(19) United States
(12) Patent Application Publication
(10) Pub. No.: US 2016/0012349 A1
(43) Pub. Date: Jan. 14, 2016

(54) LEARNING SYSTEM AND METHOD FOR CLINICAL DIAGNOSIS

(71) Applicants: Chenchun LAI, Taipei (TW); Chewei LIN, Taipei (TW); Hsinwei WANG, Taipei (TW)

(72) Inventors: Chenchun LAI, Taipei (TW); Chewei LIN, Taipei (TW); Hsinwei WANG, Taipei (TW)

(73) Assignee: CHUN SHIN LIMITED, Taipei City, TW (TW)

(21) Appl. No.: 14/424,568

(22) PCT Filed: Aug. 30, 2012
(86) PCT No.: PCT/CN2012/080762

§ 371 Date: Aug. 5, 2015

(51) Int. Cl. G06N 99/00; G06N 5/02

(52) U.S. Cl. CPC G06N 99/005; G06N 5/022

(57) ABSTRACT

The present invention provides a learning system for clinical diagnosis which comprises (a) at least one learning operation device, (b) a database device, (c) a server device and (d) at least one patient simulator device, and provides a user with training for clinical diagnosis based on a real disease case. The present invention further provides a learning method and steps for clinical diagnosis thereof.

### CROSS-REFERENCES TO RELATED APPLICATIONS

The present application claims priority to PCT/CN2012/080762, filed Aug. 30, 2012, incorporated herein by reference in it entirety.

### BACKGROUND OF THE INVENTION

1. Field of the Invention

The present invention relates to an innovation providing a learning system for clinical diagnosis training. The present invention also relates to a learning method for clinical diagnosis.

2. Description of Prior Art

To provide a correct diagnosis and care for a patient in a clinical aspect, a doctor needs to have various good training to gain the ability to correctly, flexibly and adequately apply medical knowledge to the patient's medical conditions. However, cultivated training of a doctor not only depends on the establishment of the medical knowledge itself but also the actual operational training of clinical medicine.

The main purpose of the clinical skill training is to help a student independently perform an inquiry in the future, understand a cause and clinical significance of a symptom of a patient, be able to perform a diagnostic examination by the correct procedure, and correctly interpret the physical examination data of the patient, such as common examinations comprising ECG and biochemical test (e.g. blood, urine, feces) and other clinical routine examinations. The student understands the purpose, reference value and clinical significance of the above examinations, can correctly write an objective, standardized and complete medical record of hospital in correlation with the patient. The clinical thinking training includes analyzing, summarizing, reasoning, and generalizing and providing a final correct diagnosis by an inquiry, a physical examination and other clinical examination data. Through complete medical clinical skill and thinking training, it will help a medical student make a correct diagnosis and dramatically decrease the possibility of the diagnosis error or medical negligence in clinical practice.

With the development of technology, there are commercially clinical teaching products in the present for helping a medical student learn and establish clinical knowledge, such as the use of network software, a video device, a virtual situation and a medical simulation device. It helps a medical student in school actually understand the situation of taking care of the patient. The commercially clinical teaching products in the present, medical teaching patient simulator for example, now release smart products with multifunctions including the expression of the relative disease symptom based on built-in disease models or a specific symptom set by a user, in which most of the built-in disease models directly focus on the disease which needs an emergency treatment or a surgery, and the patient simulator can generate relative changes and responses of the symptom according to the treatment administered by the user.

However, most of the patient simulator products for medical teaching in the present focus on providing the “therapy of treatment” of the disease for a user to be trained, and currently there is no product for training the clinical disease “diagnosis.” Because the provided information of the patient is limited, most of the examination data and disease symptoms of the patient simulator products for medical teaching are self-written by the manufacturers, rather than real patient data. Moreover, a teacher needs to answer a student about the inquiry content by himself, update relative biochemical examination data, and the student makes judgments merely based on the limited data and is not free to choose desired clinical examinations or obtain relative simulating data. In addition, one of the purposes of an objective diagnostic teaching will be defeated when the student may obtain the clues from the information and answer provided by the teacher and guess the simulated disease thereof.

Another disadvantage of the current commercial products is that they can not automatically determine the accuracy of the clinical diagnosis operation procedure of the user. If the student makes a misjudgment, diagnosis error or operation error during the diagnosis, the patient simulator can not directly send the message of the error user command. It still needs a senior doctor next to the student to determine the accuracy of the operation procedure of the student and provide guidance after finishing the operation. It will dramatically decrease the effect of clinical simulation training.

Because of the various defects of the current commercial simulation products for clinical training, these products thus far are unable to provide medical students a complete clinical diagnosis and skill training which focuses on both hands and brain. To help medical students effectively learn the skills of clinical diagnosis, the medical field needs a product for performing a well-simulated training for clinical diagnosis. It is also the problem that the present invention intends to solve.

### SUMMARY OF THE INVENTION

The present invention provides a learning system for clinical diagnosis, comprising: (a) at least one learning operation device, comprising a display element, an output element and an input element, wherein the output element outputs a disease case setting of a user, and the user inputs information relating to the diagnosis via the input element; (b) a database device for storing at least one information of a disease case and a preset clinical diagnosis operating parameter corresponding to the disease case; (c) a server device, being connected to the at least one learning operation device and the database device in a wireless or wired manner, for receiving the disease case setting of the user sent by the at least one learning operation device, comparing a corresponding information of the disease case stored in the database device, and delivering the corresponding information of the disease case to the at least one learning operation device and a patient simulator device; and (d) at least one patient simulator device, being connected to the server device in a wireless or wired manner and comprising at least one detection component and at least one simulation component, for receiving the information of the disease case sent by the server device, in which the at least one simulation component exhibits at least one simulated physiological message corresponding to the information of the disease case, and the at least one detection component detects a clinical diagnosis operation performed on the patient simulator device by the user, generates a clinical diagnosis operation parameter of the user and delivers the clinical diagnosis operation parameter of the user to the server device.

The present invention also provides a learning method for clinical diagnosis applying the learning system for clinical diagnosis thereof, wherein the learning system comprises at least one learning operation device, a database device, a server device, and at least one patient simulator device.

### BRIEF DESCRIPTION OF THE DRAWINGS

FIG. 1 illustrates the block diagram of the first embodiment of the learning system for clinical diagnosis of the present invention.

FIG. 2 illustrates the block diagram of the second embodiment of the learning system for clinical diagnosis connecting with a cloud server.

### DETAILED DESCRIPTION OF THE INVENTION

Aiming at the clinical diagnosis, the present invention provides a novel learning system for a simulated real situation for clinical diagnosis that overcomes many disadvantages of the learning product of the clinical patient simulator in the present and combines the training with clinical diagnosis. The present invention collects the disease data of a real patient comprising a medical record, symptoms, inquiry responses, physical examination results, clinical examination data, etc., and allows the user to perform a disease evaluation based on the condition of the real patient, freely choose the inquiry items, actually perform physical examinations, and freely choose clinical examination items. It allows the user to perform the disease diagnosis, write the medical record or determine the treatment based on the total information.

The advantage of the present invention is that it does not need the senior doctor (teacher or assistant) to assist the user (student) to judge the accuracy of the operation processes. The present invention directly provides the functions for detecting and recording all touching or non-touching diagnosis processes of the user, judges the accuracy of the clinical diagnosis of the user or further performs scoring or gives reminders. The present invention further calculates the costs and time for the clinical diagnosis of the user, and dramatically decreases the need for professional staff in the clinical diagnosis teaching. It also increases the effect of the clinical simulating training. In addition, it decreases the chances of guessing and obtaining the clues from questions and answers because the user of the present invention does not need to involve the teacher or assistant with questions and answers. Moreover, it corresponds with the real situation in which the doctor meets with the patient for the first time. It allows the user to start from the most basic inquiry and performs the clinical diagnosis training from an objective standpoint.

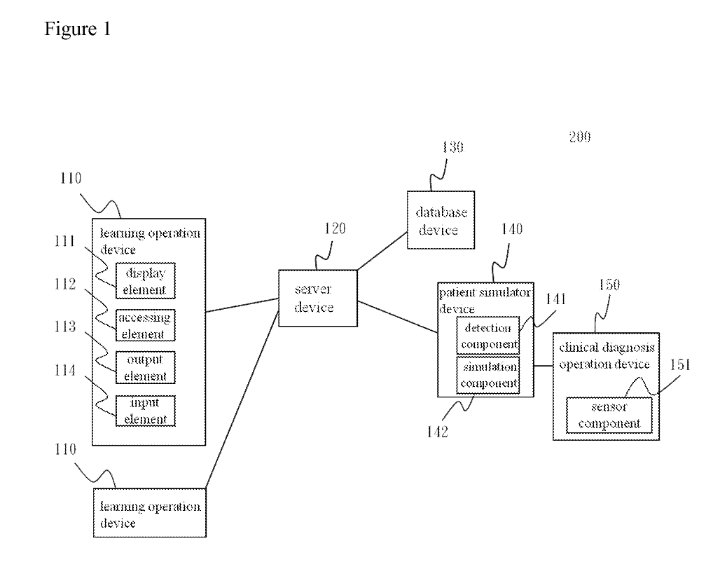

The present invention provides a learning system for clinical diagnosis (100) (FIG. 1), comprising:

at least one learning operation device (110), comprising a display element (111), an output element (113) and an input element (114), wherein the output element (113) outputs a disease case setting of a user, and the user inputs information relating to the diagnosis via the input element (114);

a database device (130) for storing at least one information of a disease case and a preset clinical diagnosis operation parameter corresponding to the disease case, in a preferred embodiment, the database device can be a data server;

a server device (120), being connected to the at least one learning operation device (110) and the database device (130) in a wireless or wired manner, for receiving the disease case setting of the user sent by the at least one learning operation device (110), comparing corresponding information of the disease case stored in the database device (130), and delivering the corresponding information of the disease case to the at least one learning operation device and a patient simulator device (140); and

the at least one patient simulator device (140), being connected to the server device in a wireless or wired manner and comprising at least one detection component (141) and at least one simulation component (142), for receiving the information of the disease case sent by the server device (120), in which the at least one simulation component (142) exhibits at least one simulated physiological message corresponding to the disease case, and the at least one detection component (141) detects a clinical diagnosis operation performed on the patient simulator device (140) by the user, generates a clinical diagnosis operation parameter of the user and delivers it to the server device (120). In a preferred embodiment, appearance of the patient simulator device (140) imitates a human structure. In another embodiment, the patient simulator device (140) has the function of processing and storing data.

The at least one learning operation device (110) delivers the disease case setting of the user to the server device (120) via the output element (113), receives the corresponding information of the disease case from the server device (120), compares a clinical diagnosis command with the information of the disease case from the server device based on the clinical diagnosis command inputted by the user via the input element (113), displays comparison by the display element (111), and delivers the clinical diagnosis command of the user to the server device (120) via the output element (113), and the server device (120) receives and records the clinical diagnosis command of the user from the at least one learning operation device (110) and the clinical diagnosis operation parameter of the user sent by the at least one patient simulator device (140), compares the same with the preset clinical diagnosis operating parameter corresponding to the disease case stored in the database device (130), and then determines accuracy.

In a preferred embodiment, the at least one patient simulator device (140) and the at least one learning operation device (110) record the clinical diagnosis operation parameter and the clinical diagnosis command of the user, respectively. The server device (120) generates a score result according to the accuracy of the clinical diagnosis related information of the user.

Moreover, the present invention provides a clinical diagnosis operation device (150) for receiving a detection signal for the physical examination from the patient simulator device. It further comprises a sensor component (151) that is used for sensing at least one simulated physiological message corresponding to the disease case exhibited by the simulation component (142) of the patient simulator device (140) and allows the clinical diagnosis operation device (150) to display the simulated physiological information. For example, the clinical diagnosis operation device (150) can be a smart stethoscope with multifunction. When the user uses the smart stethoscope with multifunction to perform physical examination on the patient simulator device (140), it is able to receive and display the detection signal, such as heart sound, lung sound, etc., according to the simulation component (142) in different locations of the patient simulator device (140) for diagnosis and provides the user with information for interpretation and diagnosis. In a preferred embodiment, the appearance of the clinical diagnosis operation device (150) imitates the appearance of a general clinical diagnostic instrument, including but is not limited to a syringe, a shock generator, a defibrillator, a stethoscope, a thermometer, a breather, a flashlight or an endotracheal intubation equipment.

The user can use the clinical diagnosis operation device (150) to perform a clinical diagnosis operation on the patient simulator device (140) and judge the disease symptoms based on the simulated physiological message exhibited by the clinical diagnosis operation device (150). In a preferred embodiment, the clinical diagnosis operation device (150) performs the detection by touching or non-touching. The patient simulator device (140) identifies or matches with the clinical diagnosis operation device (150) by the BT or RFID technique and communicates mutual information with each other. The detection component (141) of the patient simulator device (140) detects the clinical diagnosis operation performed on the patient simulator device (140) by the user by detecting the clinical diagnosis operation device (150) and generates a clinical diagnosis operation parameter of the user.

According to the learning system for clinical diagnosis in the present invention, in one embodiment, the learning operation device (110) further comprises an accessing element (112) for accessing the score result generated by the server device (120), and the stored clinical diagnosis operation parameter and clinical diagnosis command of the user.

In another embodiment, the server device is further equipped with a clinical diagnosis learning software for the function of managing a group of the patient simulator devices (140), flexibly updating the status of the patient simulator device (140), searching the current operation condition of the system, real-time transferring commands to a plurality of the patient simulator devices, and comparing the status of the patient simulator device with the diagnosis of the student. In a preferred embodiment, the clinical diagnosis learning software is DxR Clinician.

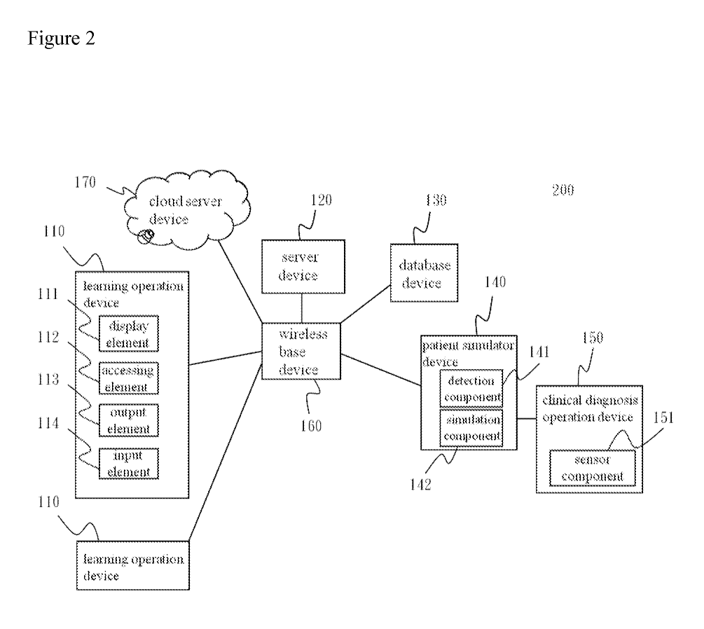

The learning system for diagnosis (200) (FIG. 2) in the present invention further comprises a wireless base device (Access Point) (160), connected to the server device, for generating a wireless transmitting environment, wherein the server device connects to other devices wirelessly via the wireless base device. In a preferred embodiment, the wireless base device is further connected to a cloud server device (170).

According to the learning system for clinical diagnosis in the present invention, in a preferred embodiment, the at least one learning operation device is a computer, a portable computer, a tablet computer, an iPad or cellular phone. In a preferred embodiment, the at least one learning operation device comprises a learning operation device for a student and a monitoring device for a director, wherein the learning operation device for the student is used for inputting the clinical diagnosis command and displaying the information of the disease case and score result, and the monitoring device for the director is used for inputting the disease case setting, accessing and analyzing the score result generated by the server device and the clinical diagnosis operation parameter and the clinical diagnosis command stored in the server device, and updating the data stored in the database device.

As used herein, the “wireless or wired manner” includes but is not limited to a NFC, WIFI, BT or HDMI.

As used herein, the “information of disease case” includes but is not limited to a medical record of a patient, at least one disease symptom, an inquiry response of a patient, a physical examination result, clinical examination datum, or a physical response message.

As used herein, the “preset operating clinical diagnosis parameter” includes but is not limited to a preset inquiry item and response, a preset physical examination, a preset clinical examination item, an interpretation result of the preset clinical examination item, a preset diagnostic result, or a preset treatment result.

As used herein, the “clinical diagnosis operation parameter” includes but is not limited to the location, time, step and operation time of the physical examination item.

As used herein, the “clinical diagnosis command” includes but is not limited to an inquiry item and response, a physical examination, a clinical examination item, an interpretation of the clinical examination item, a diagnostic result, a treatment result, or cost and operation time of a clinical diagnosis operation.

As used herein, the “clinical examination item” includes but is not limited to an imaging examination, an electrocardiography examination or a specimen biochemical examination.

In another embodiment, the learning system for diagnosis in the present invention, in which the detection component (141) is used to detect sound, light, touch, pressing, or temperature of clinical diagnosis operation performed on the patient simulator device by the user. The simulation component (142) is used for simulating sound, jitter, temperature, or action corresponding to disease case.

The present invention also provides a learning method for clinical diagnosis applying the learning system for clinical diagnosis (100) (FIG. 1) of the present invention, comprising the steps of:

inputting a disease case setting into the at least one learning operation device (110) by a user;

delivering the disease case setting to the server device (120) by the at least one learning operation device (110);

receiving the disease case setting and comparing the disease case setting with corresponding information of the disease case stored in the database device (130), and delivering the comparison to the at least one learning operation device (110) and the at least one patient simulator device (140) by the server device (120);

exhibiting at least one simulated physiological message corresponding to the information of the disease case by the at least one patient simulator device (140);

performing a clinical diagnosis operation on the at least one patient simulator device (140) based on the at least one simulated physiological message, and inputting a clinical diagnosis command, using the at least one learning operation device (110), by the user;

detecting the clinical diagnosis operation of the user, generating a clinical diagnosis operation parameter of the user, and delivering it to the server device by the at least one patient simulator device (140);

comparing by the at least one learning operation device (110) the inputted clinical diagnosis command with the information of the disease case sent by the server device (120) based on the inputted clinical diagnosis command, displaying the comparison by the display element (111), and delivering the clinical diagnosis command of the user to the server device (120) by the at least one learning operation device (110); and

via the server device (120), receiving and recording the clinical diagnosis command of the user sent back by the at least one learning device (110) and the clinical diagnosis operation parameter of the user sent back by the at least one patient simulator device (140), comparing the same with the preset operating parameter of clinical diagnosis corresponding to the disease case stored in the database device (130), and then determining accuracy.

In one embodiment, the server device (120) generates a score result according to the accuracy of the clinical diagnosis related information of the user. The user can use the at least one learning operation device (110) to access the score result generated by the server device (120), and the clinical operation parameter, and clinical diagnosis command of the user stored in the server device.

In another embodiment, the user uses a clinical diagnosis operation device (150) provided by the present invention to perform a clinical diagnosis operation on the patient simulator device (140) and judges the disease symptoms based on the simulated physiological message exhibited by the clinical diagnosis operation device (150). The user can combine the disease symptoms with the information of the disease case sent by the server device (120) based on the disease symptoms to infer a diagnostic result or a treatment result, and inputs them to the clinical diagnosis learning device (110). The detection component (141) of the patient simulator device (140) detects the clinical diagnosis operation performed on the patient simulator device (140) by the user by detecting the clinical diagnosis operation device (150) and generates a clinical diagnosis operation parameter of the user.

In another embodiment, the at least one learning operation device comprising a learning operation device for a student and a monitoring device for a director. In a preferred embodiment, in a teaching environment, a teacher can use the monitoring device for the director provided by the learning system for clinical diagnosis (100) of the present invention to input a disease case setting, store and analyze the score result generated by the server device and the clinical diagnosis operation parameter and the clinical diagnosis command stored in the server device, and update the data stored in the database device. The student can use the learning operation device for the student to input the clinical diagnosis command and display the information of a disease case and score result.

### EXAMPLES

### Example 1

Using the appendicitis as an example, the general cause of the appendicitis is the obstruction of the output of the appendix in the cecum and the bacterial infection. But the obstructions are not observed in 30% of the cases, the inflammation may be due to virus, parasites, bacterial infection, trauma or stool remaining after surgery. During a diagnosis, a doctor is required to distinguish it from no less than dozens of patient's other conditions including cholecystitis (abdominal pain at upright), ulcer (it will be more painful after moving), diverticulitis (it can palpate the tumor), partial obstruction of the small intestine (accelerated intestinal motility), intestinal perforation (slow intestinal motility). The most important diagnostic method is still a detailed medical history and physique (physical) examination. Furthermore, appendicitis is common but can be easily confused with other medical conditions because of the location and symptoms. At first it is similar to that of general abdominal pain if a doctor does not pay special attention. In addition to abdominal pain, patients with the appendicitis also suffer from decreased appetite, nausea, and vomiting, and some patients even have mild fever (about 38° C.). Additionally, some patients have increased fur on tongue, oral odor, or increased granulocytes, some patients suffer from constipation symptom, some suffer from diarrhea, even with blood in the excreta. Because the symptoms are varied, it is difficult to make a definite diagnosis.

The appendicitis progression is from a few hours to several months. It is divided into acute and chronic based on the speed of the progression, of which the acute appendicitis symptom is more severe and threatening. The early symptoms may be abdominal pain which is caused by the appendix inflammation and appendix obstruction, but it may lead to abscess and even enterobrosis after a long period of time. It is common that enterobrosis occurs at 24 to 36 hours after the onset of symptoms, but it may occur earlier in small children or the elderly.

The misdiagnosis rate of the appendicitis is not low. It needs certain procedure and method to diagnose the appendicitis and perform diagnosis via inquiry and detailed physical examination. At first, a doctor will perform a detailed inquiry of medical history. If appendicitis is suspected, the doctor performs related examination comprising the following items:

Blood test: white blood cell count exceeds 10,000/mm³ when patients suffer from the appendicitis.

Physique (physical) examination: the scope of classic symptoms of appendicitis is difficult to define at the beginning and abdominal pain gradually increases. Generally, pain begins around scrobiculus cordis or umbilicus and gradually moves to right lower abdomen. Then it is afraid to cause the contraction of the abdominal muscles, the contraction and stiffness of the abdominal muscles and rebounding pain by touching the abdomen. The checking point of the physical examination is: a doctor first presses the right lower abdomen of a patient by hands, there will be a partial rebounding pain when releasing hands; a muscle of the right waist is in pain when pulling the right leg of the patient; when the patient cross-legs by putting the right crus on the left crus, when pressing the right knee downward the patient feels pain in musculus obturators of right abdomen; finally the muscle of the right abdomen is in pain when the pressing moves to the muscle of the left abdomen.

Abdominal X-ray: The partial bowel obstruction occurs in the right lower abdomen. An abnormal intestinal gas or stercolith may be seen.

Ultrasound, computer tomography or laparoscopy: the swollen appendix swelling, ascites or abscess can be seen. This item only assists the diagnosis. The result of this examination is not conclusive and this examination is not necessarily performed.

The Training for Appendicitis Diagnosis of the Present Invention

In a learning environment, the learning system for clinical diagnosis (200) (FIG. 2) of the present invention comprises a learning operation device for a student (110) and a monitoring device for a director, wherein the monitoring device for the director owns a higher authority, can set a wanted disease case for training, access data of a server device (120), update data stored in a database device (130), control the learning operation device for the student (110) to access the data of the server device (120). During the training for diagnosis, the learning operation device for the student (110) only displays the received data of the server device (120), inputs an inquire item and diagnosis, a treatment result but can not access the data of the service device.

When the training for diagnosis started, a teacher opened the monitoring device for the director for inputting a disease case of a patient with appendicitis. The monitoring device for the director delivered the setting of the disease case of the teacher to a wireless base device (160) and the server device (120). The server device (120) received the setting of the disease case, compared the information of the disease case of the patient with the appendicitis stored in the database device and delivered the information to the learning operation device for the student (110) and a patient simulator device (140) of every student in the learning environment via the wireless base device (160).

The student performed the training for diagnosis under the condition that the student did not know what kind of a disease was presented. First, the student opened the learning operation device for the student (110) for inputting a wanted inquire item and querying a condition and medical history of the patient. The learning operation device for the student (110) compared the information of the patient with the appendicitis delivered by the server device based on the inquire item inputted by the student, found and displayed a responding answer of the patient, and also delivered the record of the inquired item inputted by the student to the server device (120). For example, the student asked the patient: “where do you feel uncomfortable”, “where do you have pain” and “how long have you had pain”, and the learning operation device for the student displayed the answers of the patient: “stomach pain”, “pain is in the right lower abdomen”, and “for a day”. According to the obtained answer from the inquiry, the student could preliminarily obtain an imitated result and input it into the learning operation device for the student (110).

Then the student used the patient simulator device (140) to perform the training for physical examination. For example, the student pressed the right lower abdomen of the patient simulator device (140) by hands and then released the hands. The detection component (141) of the patient simulator device (140) detected the pressing the right lower abdomen of the student, compared the information of the patient with the appendicitis sent by the server device, found a corresponding physiological message of the patient, and made a painful sound of the patient by a simulation component (142). At the same time, the patient simulator device (140) also recorded the physical action of the student and delivered it to the server device (120). The student inputted the corresponding physiological message of the patient obtained from the physical examination into the learning operation device for the student (110), or further confirmed or amended the imitated diagnosis result according to the result.

According to the inquiry and the physical examination result, the student used the learning operation device for the student (110) to input one of the clinical examination items to be performed, such as a blood test, an X-ray examination or an ultrasound examination. Based on the clinical examination item inputted by the student, the learning operation device for the student (110) compared the information of the patient with the appendicitis sent by the server device, and found and displayed the clinical examination result of the corresponding clinical examination item of the patient, such as a blood biochemical examination report recorded white blood cell counts >10,000/mm³, an X-ray film showing a partial bowel obstruction occurred in the lower right abdomen, an ultrasonic image of the abdomen displaying a swollen appendix. The student performed interpretation based on the clinical examination result and inputted the interpretation result of the clinical examination into the learning operation device for the student (110). The learning operation device for the student (110) also recorded and delivered the clinical examination item and the interpretation result of the clinical examination inputted by the student to the server device (120) at the same time.

The student got a final diagnosis result according to the result of the inquiry, the result of the physical examination and the result of the clinical examination or the amended imitated diagnosis result, determined the needed treatment result of the patient (a health care management and a content of a treatment), such as a surgical resection of a cecum and then using an antibiotic for treatment etc., and inputted the diagnostic result and the treatment result into the learning operation device for the student (110) and then delivered it to the server device (120). The server device (120) received and recorded the result of the inquiry, the imitated diagnosis result, the interpreted result of the clinical examination item, the diagnostic result and the treatment performed by the student, the physical examination performed by the student sent by the patient simulator device, and a preset response and inquire item of appendicitis corresponding to the information of the patient with the appendicitis, a preset physical examination, a preset clinical examination item, a preset interpreted result of a clinical examination item, and a preset diagnosis result and a preset treatment result stored in the database service (130). The server device (120) compared and judged the accuracy of the diagnostic step and the result of the student and generated a score result.

The teacher used the monitoring device for the director to access the score result of the student generated by the server device (120) and total records of the diagnostic procedure (inquiry item, interpretation of clinical examination item, and procedure and result of clinical diagnosis etc.) of the student stored in the server device (120) to evaluate the learning situation of each student. It assisted the teacher to make a score for the clinical diagnosis of the student. In addition, the teacher implemented a diagnostic step to determine how easy for a student to make a mistake based on the diagnostic record of each student and provided guidance. Moreover, after finishing the training, the server device (120) also delivered the score result and total diagnostic records stored in the server device (120) to the learning operation device for the student (110) of each student. It allowed the student to know at which steps his/her mistake occurred and whether corrections were needed.

What is claimed is:

1. A learning system for clinical diagnosis, comprising:
(a) at least one learning operation device, comprising a display element, an output element and an input element, wherein the output element outputs a disease case setting of a user, and the user inputs information relating to the diagnosis via the input element;
(b) a database device for storing at least one information of a disease case and a preset clinical diagnosis operating parameter corresponding to the disease case;
(c) a server device, being connected to the at least one learning operation device and the database device in a wireless or wired manner, for receiving the disease case setting of the user sent by the at least one learning operation device, comparing a corresponding information of the disease case stored in the database device, and delivering the corresponding information of the disease case to the at least one learning operation device and a patient simulator device; and
(d) the at least one patient simulator device, being connected to the server device in a wireless or wired manner and comprising at least one detection component and at least one simulation component, for receiving the information of the disease case sent by the server device, in which the at least one simulation component exhibits at least one simulated physiological message corresponding to the disease case, and the at least one detection component detects a clinical diagnosis operation performed on the patient simulator device by the user, generates a clinical diagnosis operation parameter of the user and delivers it to the server device,
wherein the at least one learning operation device delivers the disease case setting of the user to the server device via the output element, receives the corresponding information of the disease case from the server device, compares a clinical diagnosis command with the information of the disease case from the server device based on the clinical diagnosis command inputted by the user via the input element, displays compared result by the display element, and delivers the clinical diagnosis command of the user to the server device via the output element, and
wherein the server device receives and records the clinical diagnosis command of the user from the at least one learning operation device and the clinical diagnosis operation parameter of the user sent by the at least one patient simulator device, compares the same with the preset operating parameter of clinical diagnosis corresponding to the disease case stored in the database device, and then determines accuracy.

2. The learning system of the claim 1, wherein the at least one patient simulator device and the at least one learning operation device record the clinical diagnosis operation parameter and the clinical diagnosis command of the user, respectively.

3. The learning system of the claim 1, wherein the device generates a score result according to the accuracy of the clinical diagnosis relative information of the user.

4. The learning system of the claim 3, wherein the learning operation device further comprises an accessing element for accessing the score result generated by the server device, and the clinical diagnosis operation parameter and clinical diagnosis command of the user stored in the server device.

5. The learning system of the claim 1, wherein the sever device is further equipped with a clinical diagnosis learning software.

6. The learning system of the claim 5, wherein the clinical diagnosis learning software is DxR Clinician.

7. The learning system of the claim 1, further comprising a wireless base device, connected to the server device, for generating a wireless transmitting environment, wherein the server device connects to other devices wirelessly via the wireless base device.

8. The learning system of the claim 1, wherein the at least one learning operation device is a computer, a portable computer, a tablet computer, an iPad or a cellular phone.

9. The learning system of the claim 1, wherein the shape of the patient simulator device imitates a human structure.

10. The learning system of the claim 1, wherein the at least one learning operation device comprises a learning operation device for a student and a monitoring device for a director, in which the learning operation device for the student is used for inputting the clinical diagnosis command and displaying the information of the disease case and score result, and the monitoring device for the director is used for inputting the disease case setting, accessing and analyzing the score result generated by the server device, and the clinical diagnosis operation parameter, and the clinical diagnosis command of the user stored in the server device, and updating the data stored in the database device.

11. The learning system of the claim 1, wherein the information of the disease case is a medical record, at least one disease symptom, an inquiry response of patient, a physical examination result, a clinical examination datum, or a physical response message.

12. The learning system of the claim 1, wherein the preset clinical diagnosis operating parameter is a preset inquiry item and response, a preset physical examination, a preset clinical examination item, an interpretation result of the preset clinical examination item, a preset diagnostic result or a preset treatment result.

13. The learning system of the claim 1, wherein the detection component is used to detect sound, light, touch, pressing or temperature of clinical diagnosis operation performed on the patient simulator device by the user.

14. The learning system of the claim 1, wherein the simulation component is used for simulating the sound, jitter, temperature or action corresponding to diseases.

15. The learning system of the claim 1, further comprising a clinical diagnosis operation device for receiving a detection signal for the physical examination from the patient simulator device.

16. The learning system of the claim 15, wherein the detection signal is heart sound or lung sound.

17. The learning system of the claim 1, wherein the clinical diagnosis operation parameter of the user includes the location, time, step and operation time of the physique examination item.

18. The learning system of the claim 1, wherein the clinical diagnosis command is an inquiry item and response, a physical examination, a clinical examination item, an interpretation of the clinical examination item, a diagnostic result, a treatment result, or cost and operation time of a clinical diagnosis operation.

19. The learning system of the claim 18, wherein the clinical examination item is an imaging examination, an electrocardiography examination or a specimen biochemical examination.

20. A learning method for clinical diagnosis applying the learning system for clinical diagnosis of claim 1, in which the learning system comprises at least one learning operation device, a database device, a server device and at least one patient simulator device, the method comprising the steps of:
(a) inputting a disease case setting into the at least one learning operation device by a user;
(b) delivering the disease case setting to the server device by the at least one learning operation device;
(c) receiving the disease case setting and comparing the disease case setting with corresponding information of the disease case stored in the database device, and delivering the comparison to the at least one learning operation device and the at least one patient simulator device by the server device;
(d) exhibiting at least one simulated physiological message corresponding to the information of the disease case by the at least one patient simulator device;
(e) performing a clinical diagnosis operation on the at least one patient simulator device based on the at least one simulated physiological message, and inputting a clinical diagnosis command, using the at least one learning operation device, by the user;
(f) detecting the clinical diagnosis operation of the user, generating a clinical diagnosis operation parameter of the user, and delivering it to the server device by the at least one patient simulator device;
(g) comparing by the at least one learning operation device the inputted clinical diagnosis command with the information of the disease case sent by the server device based on the inputted clinical diagnosis command, displaying the comparison by the display element, and delivering the clinical diagnosis command of the user to the server device by the at least one learning operation device; and
(h) via the server device, receiving and recording the clinical diagnosis command of the user sent back by the at least one learning device, and the clinical diagnosis operation parameter of the user sent back by the at least one patient simulator device, comparing the same with the preset operating parameter of clinical diagnosis corresponding to the disease case stored in the database device, and then determining accuracy.

21. The learning method of the claim 20, wherein the at least one patient simulator device and the at least one learning operation device record the clinical diagnosis operation parameter and the clinical diagnosis command of the user, respectively.

22. The learning method of the claim 20, wherein the server device generates a score result according to the accuracy of the clinical diagnosis related information of the user.

23. The learning method of the claim 22, wherein the learning operation device further comprises an accessing element for accessing the score result generated by the server device, and the clinical diagnosis operation parameter and clinical diagnosis command of the user stored in the server device.

24. The learning method of the claim 20, wherein the sever device is further equipped with a clinical diagnosis learning software.

25. The learning method of the claim 24, wherein the clinical diagnosis learning software is DxR Clinician.

26. The learning method of the claim 20, which further comprises a wireless base device, connected to the server device, for generating a wireless transmitting environment, wherein the server device connects to other devices wirelessly via the wireless base device.

27. The learning method of the claim 20, wherein the at least one learning operation device comprises a learning operation device for a student and a monitoring device for a director, in which the learning operation device for the student is used for inputting the clinical diagnosis command and displaying the information of a disease case and score result, wherein the monitoring device for the director is used for inputting the disease case setting, storing and analyzing the score result generated by the server device and the clinical diagnosis operation parameter and the clinical diagnosis command stored in the server device, and updating the data stored in the database device.

28. The learning method of the claim 20, wherein the information of the disease case is a medical record, at least one disease symptom, an inquiry response of patient, a physical examination result, a clinical examination datum, or a physical response signal.

29. The learning method of the claim 20, wherein the preset operating parameter of clinical diagnosis is a preset inquiry item and response, a preset physical examination, a preset clinical examination item, a interpretation result of the preset clinical examination item, a preset diagnostic result or a preset treatment result.

30. The learning method of the claim 20, wherein the detection component is used to detect sound, light, touch, pressing or temperature of clinical diagnosis operation performed on the patient simulator device by the user.

31. The learning method of the claim 20, wherein the simulation component is used for simulating the sound, jitter, temperature or action corresponding to diseases.

32. The learning method of the claim 20, wherein the clinical diagnosis operation parameter of the user is location, time, step and operation time of the physical examination item.

33. The learning method of the claim 20, wherein the clinical diagnosis command is an inquiry item and response, a clinical examination item, an interpretation of the clinical examination item, a diagnostic result, a treatment result or cost and operation time of a clinical diagnosis operation.

34. The learning method of the claim 33, wherein the clinical examination item is an imaging examination, an electrocardiography examination or a specimen biochemical examination.
